(19) United States
(12) Patent Application Publication
(10) Pub. No.: US 2017/0002505 A1
(43) Pub. Date: Jan. 5, 2017

(54) Glued Composite Component

(71) Applicant: Fisher & Paykel Appliances Limited, Auckland (NZ)

(72) Inventors: Marco Braida, Auckland (NZ); Jess Michael Malone, Auckland (NZ)

(21) Appl. No.: 15/188,244

(22) Filed: Jun. 21, 2016

(30) Foreign Application Priority Data
Jul. 1, 2015 (NZ) 709626

(51) Int. Cl. D06F 39/14; B29C 65/48

(52) U.S. Cl. CPC D06F 39/14; B29C 65/48; B29L 2031/34

(57) ABSTRACT

A technique for minimising “blooming” or “frosting” that may occur when bonding sub-components of an article together to form a composite component with an adhesive such as cyanoacrylate. Opposed bonding regions on surfaces of first and second sub-components are bonded by the adhesive and at least one of the opposed bonding regions is provided with a depression in its surface which is capable of receiving and containing an amount of uncured/curing adhesive. The depression is preferably shaped and dimensioned so as to contain the uncured adhesive while minimising the adhesive's surface area exposed to the atmosphere. The depression may be shaped as an elongate groove along at least a part of a bonding region, such as along at least a part of the periphery of a bonding region.

### TECHNICAL FIELD

This invention relates to composite components and in particular, though not solely, to components made from at least two sub-component parts that are bonded together by an adhesive, in particular by a cyanoacrylate adhesive or cyanoacrylate-based adhesive.

### BACKGROUND ART

Components of modern devices such as electrical appliances may be formed in a variety of different ways. For example, certain components may be machined out of a larger block of material or may be moulded from a molten material as is the case with injection-moulded thermoplastics components. Some components are formed by combining two or more sub-components into a composite component in which the separate sub-components must be reliably secured together. For example, the sub-components may be attached by interlocking features of the parts, by separate fasteners or clips or they may be bonded by welding or by an adhesive.

A well-known adhesive which is suitable for bonding most materials is cyanoacrylate, for example Permabond® 737 toughened cyanoacrylate manufactured by Permabond Engineering Adhesives or Loctite® 454® cyanoacrylate manufactured by Henkel Corporation. Such cyanoacrylate adhesives are normally a “one-part” adhesive whereby curing occurs by a reaction to traces of surface moisture on the parts being bonded. A known issue with cyanoacrylate adhesives is a phenomenon known as “blooming” or “frosting” that occurs when uncured adhesive evaporates or vaporises off a part and either:
reacts with moisture in the air and falls back down onto the part as a white powdery residue, or
falls back onto a surface of the part, reacts with surface moisture and adheres to that surface to produce a diffraction layer of particles that produces a visually-perceived rainbow effect or a whitish haze on the part, depending upon the concentration of particles on the surface.

The resulting appearance is unsightly, particularly when it occurs on parts or surfaces of a component that are cosmetic or decorative in nature.

Blooming has conventionally been reduced by ensuring adequate ventilation over an assembly area, applying less adhesive and/or curing the adhesive faster. These options are often not workable, for example when once the parts are assembled the still-to-be-cured adhesive is within a partially enclosed space which is difficult to ventilate but from which adhesive vapour/bloom may still escape and then cause blooming to occur on external surfaces of the assembled part. Also, accurately and repeatedly controlling the amount of adhesive applied to a surface can be difficult in assembly-line situations, particularly when the adhesive is manually applied.

It is therefore an object of the present invention to provide a composite component, a composite lid or an electrical appliance incorporating a composite lid which will go at least some way towards overcoming the above disadvantages, or which will at least provide the public or industry with a useful choice.

### SUMMARY OF INVENTION

In a first aspect, the invention may broadly be said to consist in a composite component, comprising:
a first sub-component and a second sub-component bonded together at an interface by an adhesive, a first surface on the first sub-component and a second surface on the second sub-component meeting at the interface,
the first and second surfaces each including at least one bonding region for receiving uncured adhesive which, when cured, bonds opposed bonding regions from the first and second sub-components together, the bonding regions having a periphery, at least one of the bonding regions on the first and/or second surface including a depression either within its periphery or along at least a portion of its periphery for receiving excess uncured adhesive.

Preferably, the adhesive is a cyanoacrylate adhesive or cyanoacrylate-based adhesive.

Preferably, the depression is a continuous or semi-continuous groove or channel.

In a second aspect, the invention may broadly be said to consist in a lid, the lid being a composite component according to the first aspect.

In a third aspect, the invention may broadly be said to consist in an electrical appliance comprising:
a cabinet having an opening to allow access to an internal space of the appliance, and
a lid according to the second aspect movably connected to the cabinet such that the opening may be closed or opened.

Preferably, the electrical appliance is a laundry appliance such as a laundry clothes washing machine, in particular a top-loading laundry clothes washing machine.

The invention consists in the foregoing and also envisages constructions of which the following gives examples only. The following description will concentrate on the incorporation of embodiments of the invention within a top-loading or “vertical-axis” laundry clothes washing machine however, it will be readily appreciated by those of ordinary skill in the art that the invention is not limited to such applications. The invention is applicable generally to any glued composite components, irrespective of whether they are incorporated in an electrical/home appliance. In general, the invention is applicable to articles made by gluing opposing article sub-components using an adhesive susceptible to the aforementioned blooming problem, wherein when the sub-components have been glued and connected, the adhesive is within a fully or partially enclosed hollow volume of the article.

### BRIEF DESCRIPTION OF DRAWINGS

Preferred forms of the invention will now be described with reference to the accompanying drawings in which:

FIG. 1 is a perspective view from above of a laundry clothes washing machine incorporating a lid made in accordance with an embodiment of the present invention,

FIG. 2 is a perspective view from above of the lid of the laundry clothes washing machine of FIG. 1,

FIG. 3 is a perspective view from below of the lid of FIG. 2,

FIG. 4 is a perspective view from below of the upper piece of the lid of FIG. 2 (that is, the lower piece of the lid assembly has been removed to reveal the underside of the upper piece),

FIG. 5 is a perspective view from above of the lower piece of the lid of FIG. 2 (that is, the upper piece has been removed to reveal the upper side of the lower piece),

FIG. 6 is a close-up view of the region of the upper side of the lower lid piece of FIG. 1 that is bounded by dashed lines, and

FIG. 7 is a close-up cross-sectional view through line VII-VII of FIG. 6.

### DESCRIPTION OF EMBODIMENTS

An exemplary laundry clothes washing machine 1 of the top-loading or “vertical-axis” type is illustrated in FIG. 1. As with most electrical/home appliances, the laundry clothes washing machine 1 includes an external cabinet or “wrapper” 2 which in the present case is shaped as a substantially square or rectangular prism having open top and bottom ends. The wrapper may be formed by folding and welding/clinching painted sheet steel, for example. The top end of the wrapper is provided with a “top-deck” assembly 3 including a lid 4 and a console 5 with user input and display elements and may also house an electronic controller which controls operation of the machine. The bottom of the wrapper may be provided with an assembly 6 incorporating mounting feet.

Although not essential to the present invention, the major components within wrapper 2 will now be briefly described. An outer bowl assembly is mounted beneath assembly 3 via a suspension system such as suspension rods. A spin tub (sometimes referred to as a laundry basket) is located within the outer bowl assembly, mounted on a shaft which extends through the base of the outer bowl assembly. The spin tub receives a laundry load, via the opened lid 4, during operation of the machine. An agitator or wash plate is ordinarily provided within the spin tub, connected to the upper end of the shaft which passes through seals in the bases of both the outer bowl assembly and the spin tub. The lower end of the shaft may be driven directly by an electric motor which may be an electronically commutated external-rotor motor wherein the stator is mounted to the base of the outer bowl assembly with the rotor directly connected onto the end of the shaft. Examples of such laundry clothes washing machines are our own SMARTDRIVE™-powered top-loading laundry clothes washing machines variously sold under the trade marks CLEANSMART, WASHSMART, AQUASMART, FABRICSMART and QUICKSMART.

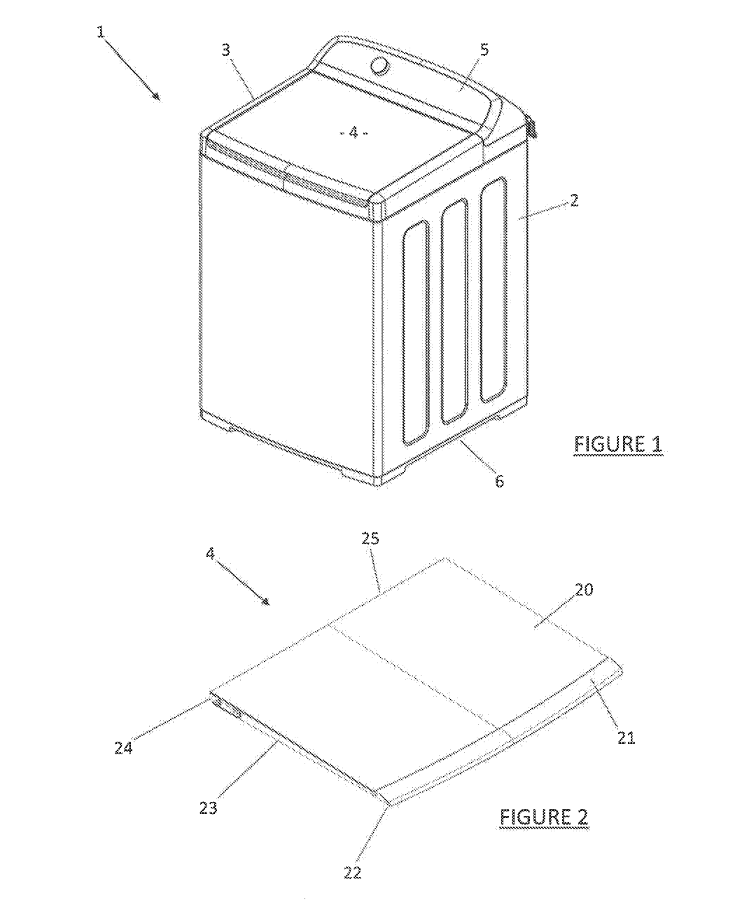

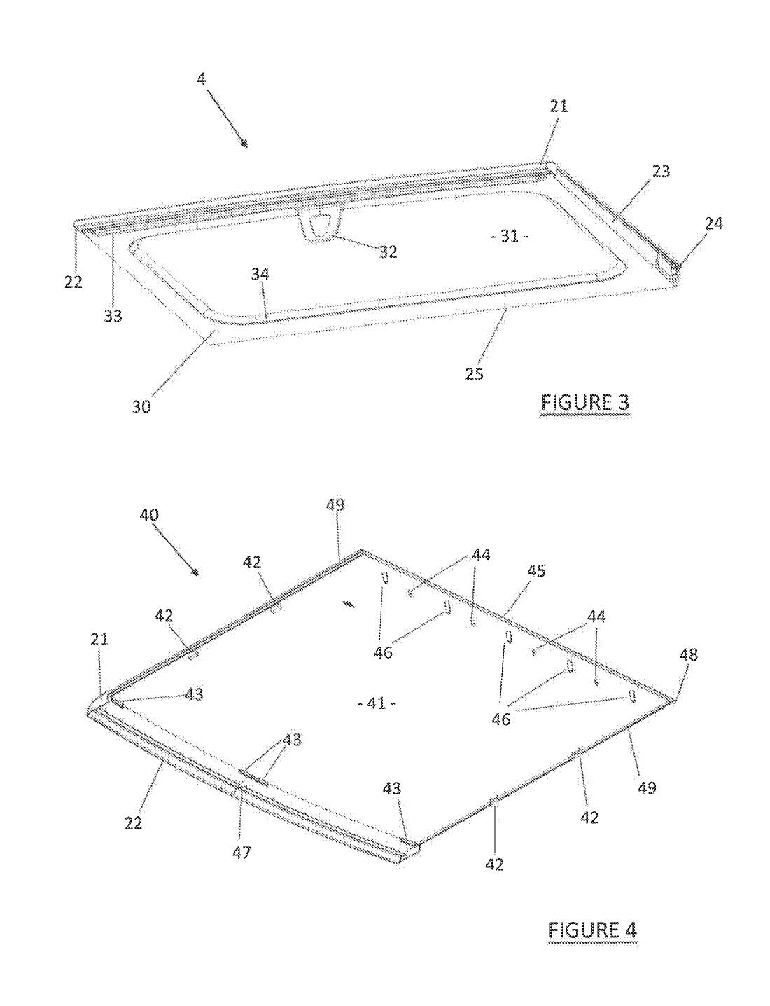

Lid 4 is a composite component manufactured in accordance with a preferred embodiment of the present invention. Sub-components of lid 4 may be formed by an injection moulding operation preferably utilising a thermoplastics material such as ABS (Acrylonitrile Butadiene Styrene). As shown in FIGS. 2 and 3, where the lid is shown in isolation, the lid has upper 20 and lower 30 surfaces. Upper surface 20 is substantially flat and smooth with a handle feature 21 at its front edge. When viewed from above and from the side, handle feature 21 may be gently curved and its front edge forms a lip 22 which is graspable by a user in order to move the lid between open and closed positions. The handle feature 21 may be provided with a glossy surface finish which may be in contrast with the substantially planar upper surface 20 which may, for example, be chemically etched to produce a textured surface.

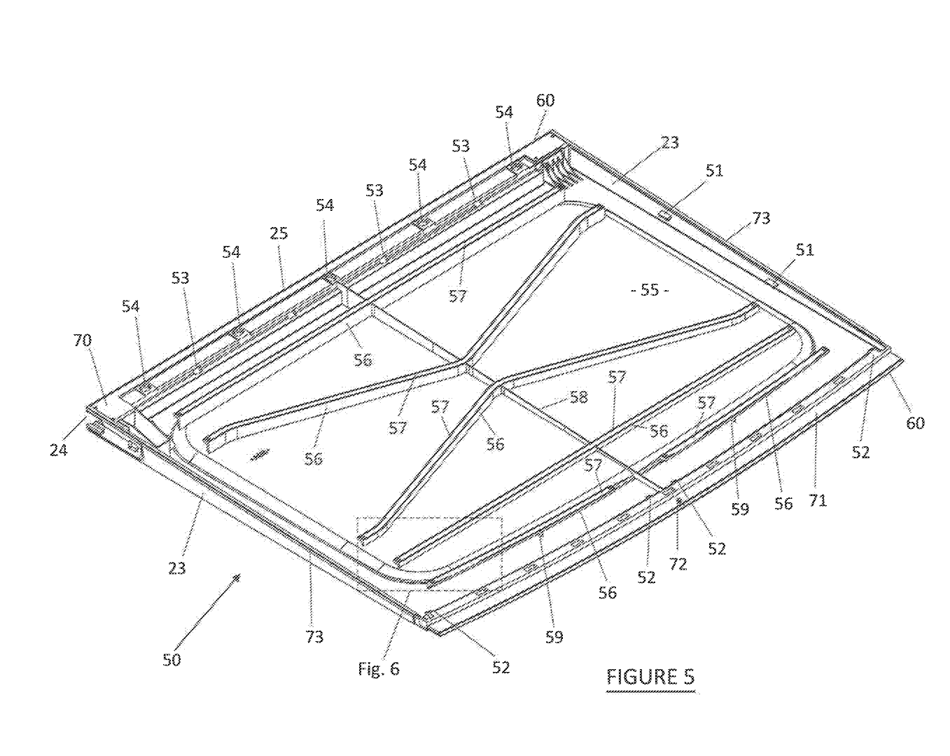

Lid 4 also includes side walls 23 between the upper 20 and lower 30 surfaces. As will be appreciated from FIGS. 4 and 5, which show respectively the upper 40 and lower 50 sub-components or pieces or parts of lid 4, the side walls 23 are provided on the lower part of the lid in this exemplary embodiment. As evident in FIGS. 2 and 3, the side walls 23 are provided with openings 24 at or near the rear edge 25 of lid 4. Openings 24 are provided to enable a hinge arm to be mounted within the lid and to extend therefrom for coupling to a hinge/damper assembly (not shown) mounted within top-deck assembly 3, adjacent to a side wall 23 of the lid.

It will be appreciated from FIG. 3 that the lower surface 30 of the lid includes a central recessed region 31. The peripheral rim 34 of recessed region 31 ensures that, during operation of the appliance, condensed or splashed water on the underside of the lid drips back into the outer bowl rather than running down the outside of the wrapper. The underside of the lower part 50 of the lid is also provided, in the exemplary embodiment, with a lug 32 (see FIG. 3) having a central opening for engagement with a lid lock (not shown) which is mounted within the top-deck assembly 3, near the centre front of machine 1.

Referring now in particular to FIGS. 4 and 5, it may be appreciated that lid 4 is essentially a composite of the upper 40 and lower 50 lid sub-components. A further sub-component which is a rubber or elastomeric buffer strip 33 (see FIG. 3) may be retained within a groove formed near the front edge of the lower surface 30 of the lower part 50 of the lid. In the closed position of the lid, buffer strip 33 rests upon a surface or ledge formed in top deck assembly 3 such that the upper surface 20 of the lid is then substantially flush with the adjacent surrounding surfaces of top-deck assembly 3. The respective upper 40 and lower 50 lid sub-components may each be formed as separate unitary parts.

The lower side 41 of upper lid sub-component 40, as shown in FIG. 4, is provided with plural projecting tabs 42 which are positioned to each contact, or be substantially contactable with, when the upper and lower sub-components are correctly aligned, an upper surface of a corresponding projecting part 51 projecting inwardly from the internal sides of each side wall 23 of lid lower sub-component 50. Similarly, retainer features 43 are provided on lower side 41 of upper lid sub-component 40 near handle feature 21. Inwardly-directed projections 52 are provided in corresponding positions near the front edge of lower lid sub-component 50 which are held by retainers 43 when the lid sub-components are correctly aligned and assembled together. Further flexible hooked rear clip projections 44 extend substantially perpendicularly from underside 41 of upper lid sub-component 40 near its rear edge 45. Projections 44 are received and retained within openings 53 formed near the rear side 25 of lower lid sub-component 50 when the lid sub-components are correctly aligned and assembled together.

Alignment of the upper 40 and lower 50 lid sub-components is assisted, during assembly of the composite lid 4, by the provision of a number of pins or posts 46 projecting substantially perpendicularly from underside 41 of upper lid sub-component 40 near its rear edge 45. Each post 46 has a corresponding opening 54 provided in lower lid sub-component 50 near its rear side 25. Posts 46 could of course alternatively be provided on lower sub-component 50 with openings 54 on upper sub-component 40. Preferably the edges of openings 54 are bevelled or curved inwardly to assist with alignment and insertion of the posts within the openings when the lid sub-components are being assembled to form the composite lid component 4.

Preferably the openings are rectangular or oval in shape rather than circular so that they allow limited relative movement in a preferred direction, although it is also preferred that the longer dimension of the respective openings are not all aligned. That is, it will be appreciated that the central opening 54 shown in FIG. 5 is aligned with its longer dimension substantially parallel with a line between the front and rear 25 edges of the lid sub-component whereas the other openings 54 have their longer dimension aligned substantially parallel with a line between and perpendicular to side walls 23. In this way, the central opening 54 controls the lateral or side to side locating of the upper sub-component to the lower sub-component while the remaining openings 54, which are spread between side walls 23, control the front to back locating of the two sub-components and ensure a uniform gap is provided between the rear of the lid component 4 and the adjacent edge of the console 5. A further locating pin 72 may be provided towards the centre of front flange 10 surface 71 of lower lid sub-component 50 which may be received within a corresponding opening or cut-out region 47 formed in a surface of the underside of handle feature 21 of the upper lid sub-component. The length of each post 46 is preferably sufficient to enable the upper lid sub-component to be placed on a flat surface, supported only by lip 22 of handle feature 21 and the tips of the posts so that the shorter front, side and rear projections or clip features on the underside 41 of the upper lid sub-component are protected from damage.

With reference now in particular to FIGS. 5 to 7, it will be appreciated that the upper surface 55 of the lower lid sub-component 50 is provided with a series of ribs 56 protruding therefrom. In the exemplary embodiment described herein the ribs follow a longitudinal path, generally from or near one side 23 of the lower lid sub-component to the other side 23. Ribs 56 have a substantially inverted “L” shape in cross-section, with a substantially planar upper surface having a bonding region 57 on which adhesive or glue, preferably a cyanoacrylate adhesive or cyanoacrylate-based adhesive, may be applied, spaced away from surface 55. A strengthening rib 58 may be provided from front to rear, running through ribs 56 to strengthen both the lid and ribs 56. Further support ribs 59 may also be provided between surface 55 and the substantially planar upper surface of ribs 56, primarily to assist in retaining upper surfaces of ribs 56 (that is, effectively the bonding regions 57 thereon) in their moulded orientation relative to surface 55 during cooling when the lower lid sub-component has been formed by plastics injection moulding. It will be noted that the upper 30 surfaces of ribs 56 are in a plane that is at an angle to surface 55 as lid component 4 is wedge-shaped, having a vertical thickness that tapers towards handle feature 21 from a maximum thickness at rear edge 25.

Adhesive is preferably also applied to the upper surfaces of inwardly-directed projections 51 on either side of lower lid sub-component 50 to bond them to a corresponding projecting tab 42 on upper lid sub-component 40. Adhesive is also preferably applied to substantially planar rear flange surface 70 and substantially planar front flange surface 71 of the lower lid sub-component, both of which also form bonding regions for bonding those surfaces to adjacent regions of surface 41 of the upper lid sub-component 40 when aligned and assembled.

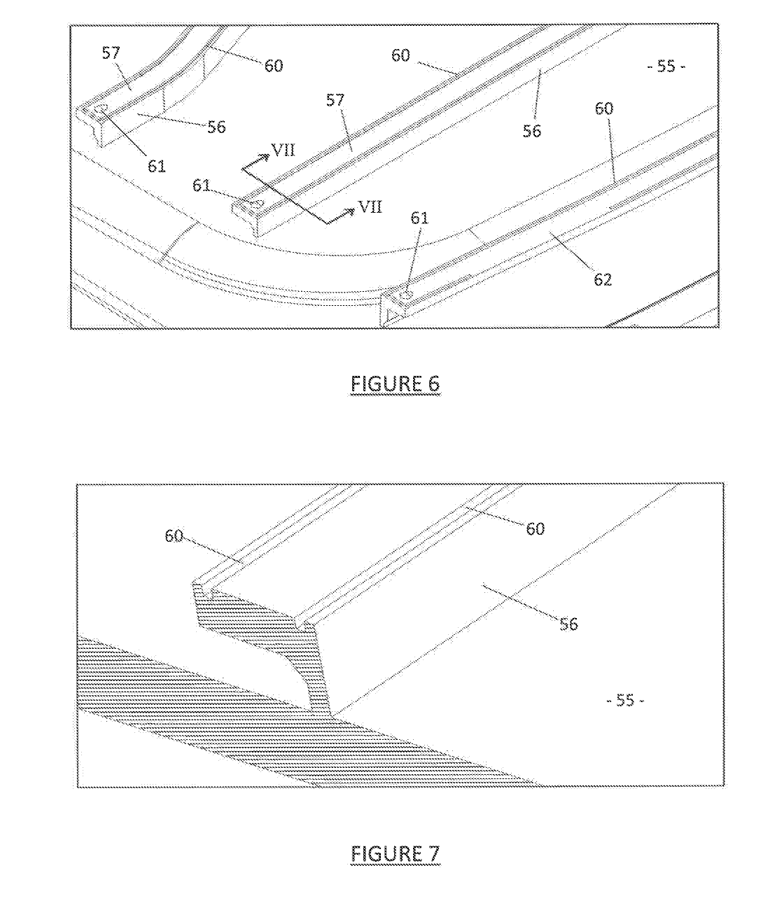

The longitudinal path has a much greater length than width and provides a suitable surface area to which adhesive may be applied from a nozzle of an adhesive dispenser. For example, a user or robotic device would place the tip of the dispenser at a starting position at or near one end of a bonding region, commence squeezing or dispensing adhesive whilst moving the tip of the dispenser along the longitudinal path and stop moving and dispensing adhesive once the other end of the path is substantially reached. A guide or stencil may be provided, covering most of the area of the lower lid sub-component 50 but having openings formed as slots above the bonding regions 57 to assist a user to manually apply adhesive in the correct locations. To assist in placement of the tip of the adhesive dispenser at the start of the adhesive application path a depression 61 may be formed within the bonding region 57, at or near an end of the longitudinal path. The shape/area and/or depth of the further depression 61 should be sufficient to enable the tip of the adhesive dispenser to be at least partially received therein. The depressions 61 are preferably positioned laterally near the centre line of the longitudinal path to assist centering of the adhesive application path. Further depressions 61 could also be provided at or near the completion end of the adhesive application path. As may be best seen in FIG. 6, depressions 61 may be shaped with a vertex directed towards the longitudinal path to assist or bias the tip of the adhesive dispenser in the correct direction along the path of the bonding region 57. For example, the depressions may be substantially rain-drop shaped. When the upper and lower lid sub-components are correctly aligned and clipped together, the upper surfaces of ribs 56 (and in particular, bonding regions 57) are in contact with, or contactable with via the adhesive, and substantially parallel to, corresponding regions of underside 41 of the upper lid sub-component 40.

It will be appreciated that when the upper and lower lid sub-components are assembled together, the composite lid component 4 thus produced will be substantially hollow such that the sub-components at least partially enclose a central volume of air. As mentioned above, it is difficult to control adhesives curing within an enclosed space so that blooming will occur, particularly where excess uncured cyanoacrylate adhesive is present on a surface which is not in contact with or adjacent to another surface which the adhesive may contact. The surface of such excess uncured adhesive is therefore exposed to the atmosphere and may easily evaporate or vaporise, particularly in a warm ambient environment. As the lid sub-components are not hermetically sealed, some of the adhesive vapour will inevitably find its way out of the composite lid and can result in blooming on external, potentially cosmetic, surfaces.

To avoid or reduce blooming on external surfaces of the composite lid component 4 the bonding regions 57 may be partially or completely bounded on their periphery by a further depression 60 which may be formed as a trench, channel or groove in the substantially planar upper surface of rib 56. Groove 60 is provided to receive excess or overflowing adhesive that has been applied to bonding region 57. Compared to the situation where uncured adhesive on a surface is completely exposed (for example, if excess adhesive overflowed the edge of the substantially planar upper surface of a rib 56 and ran down towards or onto surface 55), adhesive received by groove 60 has only a limited exposed surface area, being the width of the groove, from which any uncured adhesive may evaporate or vaporise. Accordingly, any adhesive received in groove 60 will eventually cure without significantly evaporating, thereby reducing or avoiding the occurrence of blooming. The width of the bonding region, between grooves 60 on either lateral side of the longitudinal path, is chosen to allow the uncured adhesive to spread sufficiently so that the width of bond created between the sub-components will provide adequate strength to the composite component. As shown in FIG. 5, grooves 60 may also be provided to bonding regions on flange surfaces 70 and 71 to capture excess adhesive applied to those surfaces.

Once adhesive has been applied to the bonding regions 57, and before the adhesive has completely cured, the upper 40 and lower 50 lid sub-components are aligned and clipped together. This process will result in an adhesive interface being formed between the sub-components, the interface including the bonding regions 57 of the lower lid sub-component and adjacent regions of underside 41 of the upper lid sub-component. The opposed surfaces meeting at the interface may be in contact or slightly spaced, provided that the adhesive layer is sufficiently thick to span the gap between the sub-components and thereby bond them together. Pressure may be applied between the sub-components during curing for a period of, for example, 10 to 30 seconds to ensure that a strong bond is achieved.

Although the grooves are described above as bounding a bonding region 57, a reduction in blooming will still occur if the bonding region is not completely surrounded by groove 60. For example, it can be seen in FIG. 6 that the lower rib 56 has a gap 62 in the groove on one side of the bonding region. Alternatively, the groove may be provided on only one side of the bonding region, or may be provided on one or both sides and/or ends but be discontinuous. For example, the groove may be made up of groove segments spaced apart by non-grooved segments. Furthermore, a depression or groove may, in addition or alternatively, be provided within one or more bonding region 57 to receive and store excess adhesive.

To further reduce or control the occurrence of blooming on external surfaces of the lid component seals may be formed between the two sub-components, preferably along peripheral edges thereof. For example, a lip 48 may be provided at the rear of the upper lid sub-component 40 which partially overlaps with the rear edge 25 of the lower sub-component. The clearance between the lip and rear edge 25 is minimal to reduce or resist vapour, particularly originating from flange 70, from exiting the composite lid component and forming bloom on the console 5. A similar constriction may be provided at the front edge to control vapour, particularly from flange region 71, from exiting the lid component between the front edge of lower sub-component 50 and the adjacent surface of handle region 21. The sides of the lid may be similarly sealed, for example by providing a recess or groove along the length of the side edges of one of the sub-components and a correspondingly-shaped ridge provided along the length of the side edges of the other side component. For example, upper lid sub-component 40 is provided with side grooves 49 while the side edges 73 of lower lid sub-component 50 have a profile that fits within corresponding groove 49 with minimal clearance therebetween. When assembled, the gap between groove 49 and side edges 73 provide a substantially u-shaped tortuous path in cross-section, resisting vapour flow from the sides of the lid component to the adjacent surface of top deck 3.

In the exemplary embodiment shown in the drawings, the lateral width of the grooves 60 between substantially parallel side walls may be between about 0.25 mm and about 1.0 mm, preferably about 0.5 mm and the depth at least about 0.25 mm, preferably at least about 0.5 mm with a lateral bonding region 57 width of between about 5 mm and about 10 mm. The specific dimensions of the grooves are of course not essential to the invention and it is also not essential that all of the grooves in a particular sub-component, or even all of the grooves associated with a particular bonding region 57, have the same dimensions or that they all be associated with the same groove pattern.

1. A composite component, comprising:
a first sub-component and a second sub-component bonded together at an interface by an adhesive, a first surface on the first sub-component and a second surface on the second sub-component meeting at the interface,
the first and second surfaces each including a bonding region for receiving uncured adhesive which, when cured, bonds opposed bonding regions from the first and second sub-components together, at least one of the bonding regions having a periphery including a depression either within its periphery or along at least a portion of its periphery for receiving and containing excess uncured adhesive.

2. The composite component as claimed in claim 1, wherein the adhesive is a cyanoacrylate adhesive or cyanoacrylate-based adhesive.

3. The composite component as claimed in claim 1, wherein the depression is a continuous or semi-continuous groove or channel.

4. The composite component as claimed in claim 1, wherein the depression has at least one pair of opposed and substantially parallel side walls.

5. The composite component as claimed in claim 4, wherein the pair of side walls are spaced apart by a distance of between about 0.25 mm and about 1.0 mm.

6. The composite component as claimed in claim 4, wherein the depth of the depression, in a direction substantially perpendicular to the surface of the bonding region, is at least about 0.25 mm.

7. The composite component as claimed in claim 1, wherein the depression is provided within the periphery of or along at least a portion of the periphery of only one of the bonding regions.

8. The composite component as claimed in claim 7, wherein the first sub-component includes plural first surfaces each including separate bonding regions and wherein the second surface includes a corresponding bonding region for each bonding region of the first surfaces, the bonding regions of the second surface comprising separate regions of a larger single continuous surface.

9. The composite component as claimed in claim 1, wherein opposed bonding regions of the first and second surfaces are substantially parallel.

10. The composite component as claimed in claim 1, wherein the at least one bonding region which includes a depression has a longitudinal length dimension following an open or closed path and a lateral width dimension, substantially perpendicular to the path of the longitudinal length dimension, that is shorter than the longitudinal length dimension.

11. The composite component as claimed in claim 10, wherein the depression is provided along at least a portion of a lateral side of the open or closed path of the at least one the bonding region.

12. The composite component as claimed in claim 1, further comprising a bonding region depression within the bonding region.

13. The composite component as claimed in claim 1, wherein the first and/or second surfaces are spaced away from and substantially parallel to a base surface of their respective first or second sub-component.

14. A lid, the lid being a composite component as claimed in claim 1.

15. An electrical appliance comprising:
a cabinet having an opening to allow access to an internal space of the appliance, and
a lid as claimed in claim 14 movably connected to the cabinet such that the opening may be closed or opened.

16. An electrical appliance as claimed in claim 15, the electrical appliance being a laundry appliance.
